(19) United States
(12) Patent Application Publication
(10) Pub. No.: US 2009/0174607 A1
(43) Pub. Date: Jul. 9, 2009

(54) Antenna

(75) Inventors: Gang Yan, Beijing (CN); Xiaolin Zhang, Beijing (CN); Lili Fan, Beijing (CN); Bin Cui, Beijing (CN)

Correspondence Address: SCHWEGMAN, LUNDBERG & WOESSNER, P.A., P.O. BOX 2938, MINNEAPOLIS, MN, 55402, US

(73) Assignees: Beijing Lenovo Software Ltd., Beijing (CN); Lenovo (Beijing) Limited, Beijing (CN)

(21) Appl. No.: 12/317,475

(22) Filed: Dec. 23, 2008

(30) Foreign Application Priority Data
Dec. 24, 2007 (CN) 200710304075.9

(51) Int. Cl. H01Q 9/26; H01Q 1/48; H01Q 1/36

(52) U.S. Cl. 343/700 MS; 343/846

(57) ABSTRACT

The invention discloses an antenna, which comprises a reference ground, a first radiation branch and a second radiation branch. The reference ground comprises a first grounding point and a second grounding point; the first radiation branch is connected to the reference ground via the first grounding point; the second radiation branch is connected to the reference ground via the second grounding point; wherein a slot is formed between the first radiation branch and the second radiation branch, and a distributed capacitance for coupling a signal is formed by coupling the first radiation branch and the second radiation branch via the slot; a connecting point is a feeding point via which one end of the second radiation branch for coupling the signal is connected to a radio frequency (RF) feed line, the feeding point arranged between the first grounding point and the second grounding point. The antenna of the present invention has advantages as follows: since a coplanar wave-guide coupling structure is used between the antenna resonant branches, which is equivalent to a capacitance loading, and a field loaded by the distributed capacitance is mainly concentrated in the air, thus a power loss caused by a resistor in a device after a lumped parameter capacitor is loaded is avoided. Therefore, the resonant frequency of the antenna and the size of the antenna are reduced.

### BACKGROUND OF THE INVENTION

1. Field of Invention

The present invention relates to an antenna technique for a communication terminal, especially an antenna.

2. Description of Prior Art

When a multi-antenna system is used on a notebook, a plurality of antenna units are needed to be installed simultaneously. However, a space for installing the antenna units is limited, and there must be a sufficient distance between the antenna units so as to reduce the coupling. Thus, the space occupied by each of the antenna units has to be reduced. Generally, a notebook antenna may be installed on the edge of the notebook with a strip shape. It is generally specified that the size of the antenna unit is about ¼ of a wavelength. Thus, the size of the antenna unit is about 80-90 mm at a GSM band of 900 MHz. The space between the antenna units may be larger than ⅓ of the wavelength, i.e. 110 mm. It needs about 270 mm for installing two antenna units. Considering further antenna with different frequency band, such as a WLAN antenna of 2.4 GHz, to be installed, the side length of the notebook needs to exceed 300 mm. The requirement on size is contradictory to the trend of a miniaturization design for the notebook.

Currently, a lumped parameter loading or a folded dipole may be utilized in reducing the size of the antenna. Also, the size of antenna may be reduced by slotting and slitting a radiator. However, there exist at least the following problems in the prior art:

although the size of the antenna may be reduced by utilizing a capacitance or an inductance as a load, which causes a lower actual gain of the antenna by the power loss in the device at a mobile communication frequency (higher than 800 MHz). The folded dipole may reduce the size of the antenna, but when the folded dipole is used at the edge of the notebook, the radiation space is so limited and the radiation impedance is very low, since the radiator is very close to a metal frame of the notebook. Thus, it is difficult in impedance matching, and a bandwidth of the antenna is narrow; and although the slotting and slitting may reduce the size of the antenna, it often has no sufficient space for slotting and slitting, since the antenna of the notebook is generally needed to be installed on the edge of a screen of the notebook.

### SUMMARY OF THE INVENTION

Accordingly, the present invention provides an antenna, which may reduce resonant frequency of the antenna and the size of the antenna.

In order to achieve the above objects, a technical solution of the present invention is implemented as follows:

An antenna, comprising a reference ground, a first radiation branch and a second radiation branch; wherein

the reference ground comprises a first grounding point and a second grounding point;
the first radiation branch is connected to the reference ground via the first grounding point;
the second radiation branch is connected to the reference ground via the second grounding point;
wherein a slot is formed between the first radiation branch and the second radiation branch, and a distributed capacitance for coupling a signal is formed by coupling the first radiation branch and the second radiation branch via the slot;
a connecting point via which one end of the second radiation branch for coupling the signal is connected to a radio frequency (RF) feed line is a feeding point, the feeding point being arranged between the first grounding point and the second grounding point.

Preferably, the first radiation branch is a coplanar wave-guide coupling radiation branch.

The second radiation branch is a planar inverted-F antenna radiation branch.

Non-grounding ends of the first radiation branch and the second radiation branch extend in a same direction or in different directions.

The RF feed line is any one of a coaxial line, a micro-strip line, a strip line, or a wave guide.

The coplanar wave-guide coupling radiation branch is a zigzag sheet metal or in a three-dimensional (3D) structure formed by folding a planar sheet metal.

The planar inverted-F antenna radiation branch is a T-shape sheet metal or in a 3D structure formed by folding a planar sheet metal.

The reference ground is a planar sheet metal, or in a 3D structure formed by folding the planar sheet metal.

The antenna of the present invention has advantages as follows: since a coplanar wave-guide coupling structure is used between the antenna resonant branches, which is equivalent to a capacitance loading, and a field loaded by the distributed capacitance is mainly concentrated in the air, thus a power loss caused by a resistor in a device is avoided for no lumped parameter device loaded. Therefore, the resonant frequency of the antenna and the size of the antenna are reduced.

### BRIEF DESCRIPTION OF THE DRAWINGS

FIG. 1 is an illustrative diagram of a first embodiment according to the present invention;

FIG. 2 is a view of an effect of the first embodiment according to the present invention;

FIG. 3 is an illustrative diagram of a second embodiment according to the present invention;

FIG. 4 is a view of an effect of the second embodiment according to the present invention;

FIG. 5 is an illustrative diagram of a third embodiment according to the present invention;

FIG. 6 is an illustrative diagram of a fourth embodiment according to the present invention;

FIG. 7 is an illustrative diagram of a simulation parameter according to one embodiment of the present invention;

FIG. 8 is a coordinate system view in a radiation direction according to one embodiment of the present invention;

FIG. 9 is a 3D view for an antenna gain at a GSM frequency band according to one embodiment of the present invention;

FIG. 10 is an X-Y planar projection view for the antenna gain at the GSM frequency band according to one embodiment of the present invention;

FIG. 11 is an X-Z planar projection view for the antenna gain at the GSM frequency band according to one embodiment of the present invention;

FIG. 12 is a Y-Z planar projection view for the antenna gain at the GSM frequency band according to one embodiment of the present invention;

FIG. 13 is a 3D view for an antenna gain at a DCS/PCS frequency band according to one embodiment of the present invention;

FIG. 14 is an X-Y planar projection view for the antenna gain at the DCS/PCS frequency band according to one embodiment of the present invention;

FIG. 15 is an X-Z planar projection view for the antenna gain at the DCS/PCS frequency band according to one embodiment of the present invention; and

FIG. 16 is a Y-Z planar projection view for the antenna gain at the DCS/PCS frequency band according to one embodiment of the present invention.

### DETAILED DESCRIPTION OF PREFERRED EMBODIMENTS

In the present invention, a capacitance is formed by a coupling between radiation branches of an antenna, so as to reduce the number of elements and space for insulation, and lessen the size of the antenna. The antenna of the present invention is more suitable for an antenna size requirement of a portable device.

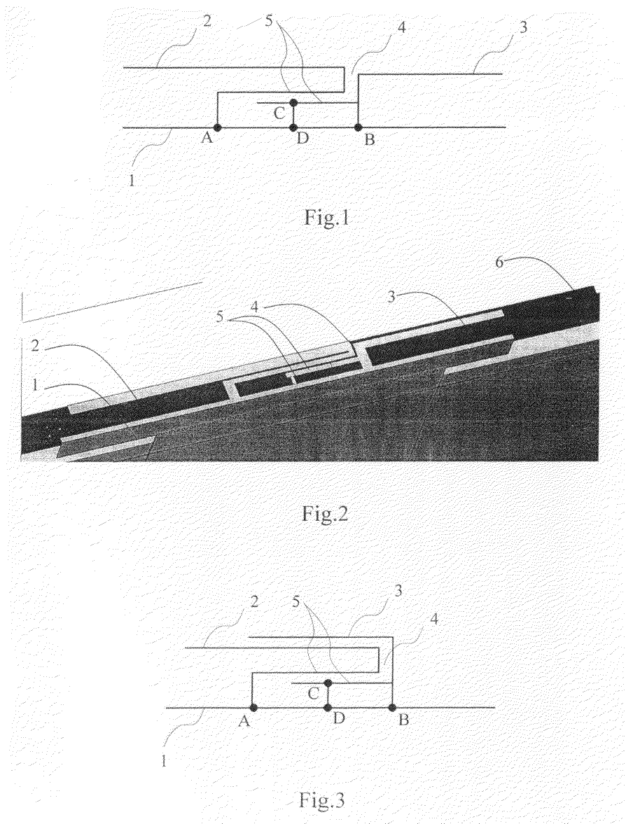

FIG. 1 is an illustrative diagram of a first embodiment according to the present invention. As shown in FIG. 1, a coplanar wave-guide coupling dual-frequency antenna consists of a reference ground 1, a coplanar wave-guide coupling radiation branch 2 and a planar inverted-F antenna radiation antenna (Pifa) radiation branch 3. The reference ground 1 is a planar metal in a structure of a narrow strip. The coplanar wave-guide coupling radiation branch 2 is a zigzag narrow strip sheet metal. One end of the coplanar wave-guide coupling radiation branch 2 is parallel to the reference ground 1, and a connecting point at which the other end of the coplanar wave-guide coupling radiation branch 2 is connected to the reference ground 1 is referred as a grounding point A. The Pifa radiation branch 3 is a T-shape sheet metal. A connecting point at which the Pifa radiation branch 3 is connected to the reference ground 1 is referred as a grounding point B. One branch end is a feeding point C, and the other branch is a radiation branch and the end of which is floated. There is no direct electric connection between the coplanar wave-guide coupling radiation branch 2 and the Pifa radiation branch 3. Rather, it is relying on coupling of a slot 4 for feeding that a distributed capacitance is formed.

A coplanar wave-guide coupling structure 5 consists of a turning-back part of the coplanar wave-guide coupling radiation branch 2 and a non-radiation coplanar coupling of the Pifa radiation branch 3. The coplanar wave-guide coupling structure 5 is connected to the reference 1 via a coaxial line. The feeding point C is connected to a conductor inside the coaxial line, and the connecting point D of the reference ground 1 is connected to a conductor outside the coaxial line. Such a structure is equivalent to a capacitance loading, which may reduce a resonant frequency of the antenna. The coplanar wave-guide coupling radiation branch 2 is resonant at a low frequency band (GSM 960 MHz), and the Pifa radiation branch 3 is resonant at a high frequency banc (DCS/PCS 1800 MHz). The entire antenna is in a structure of a narrow strip. FIG. 2 is a view of an effect of the first embodiment. The antenna may be attached along an edge of a notebook casing or a liquid crystal screen 6, and have a direction pattern and a gain approaching an omni-direction.

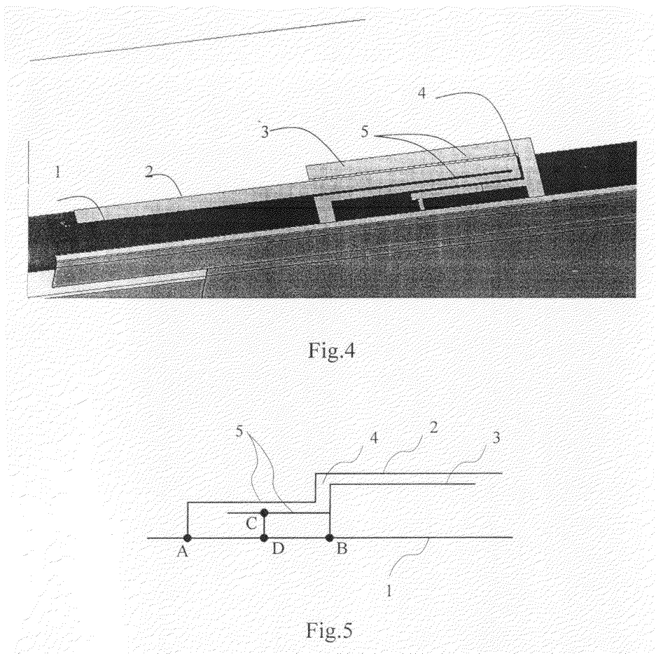

FIG. 3 is an illustrative diagram of a second embodiment according to the present invention. The radiation end of the Pifa radiation branch 3 is changed to extend to the side of the coplanar wave-guide coupling radiation branch 2, which is the same as the extending of the radiation end of the coplanar wave-guide coupling radiation branch 2. The Pifa radiation branch 3 and the coplanar wave-guide coupling radiation branch 2 are both in a three-dimensional structure of a folded planar sheet metal. Thus, a length of the slot 4 is increased, so that the resonant frequency is reduced to meet different requirements. FIG. 4 is a view of an effect of the second embodiment. As seen from FIG. 4, an outline dimension of the antenna is different from that in the first embodiment, which may meet the requirements better.

FIG. 5 is an illustrative diagram of a third embodiment according to the present invention. The radiation end of the coplanar wave-guide coupling radiation branch 2 extends to the side of the Pifa radiation branch 3, which is the same as the extending of the radiation end of the Pifa radiation branch 3. This may also increase the length of the slot 4. Additionally, the reference ground 1 may be designed to the 3D structure into which the planar sheet metal is folded, so as to meet different requirements for space.

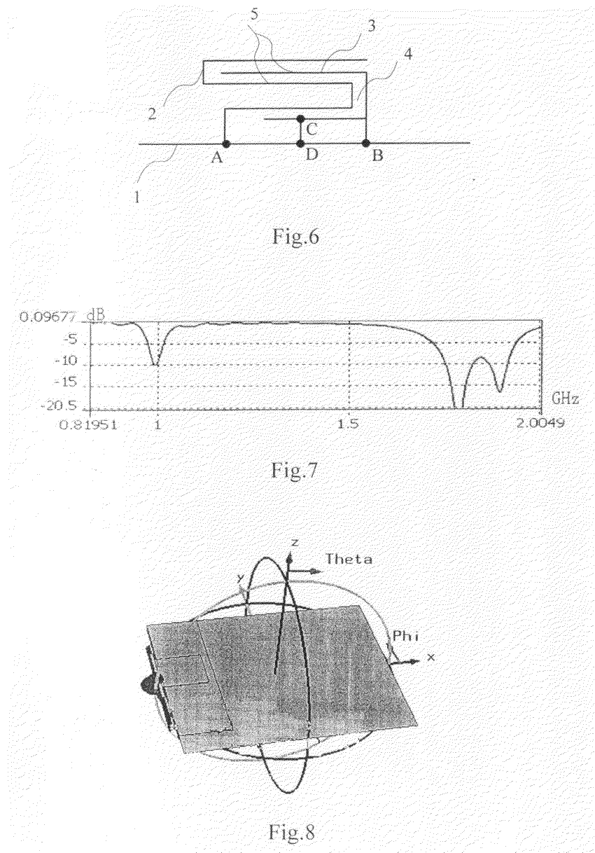

FIG. 6 is an illustrative diagram of a fourth embodiment according to the present invention. The radiation end of the coplanar wave-guide coupling radiation branch 2 is in the opposite direction to the radiation end of the Pifa radiation branch 3, i.e. extends in the opposite direction, in order to further reduce the size of the antenna. Herein, the length of the slot 4 is increased. The resonant frequency may be increased by adjusting the width of the slot 4, so as to meet the requirements. The RF feed line connected between the feeding point C and the connecting point D of the reference ground 1 may also be a micro-strip line, a strip line or a wave-guide, etc.

FIG. 7 shows an echo loss measured at the feeding point C according to simulation experiments. The echo loss values may be about −10 dB and −20 dB respectively near the frequency of 980 MHz and 1780 MHz which are exactly in the GSM frequency band and the DCS/PCS frequency band. Thus, it is illustrated that the performance of the antenna according to the present invention may satisfy the requirements

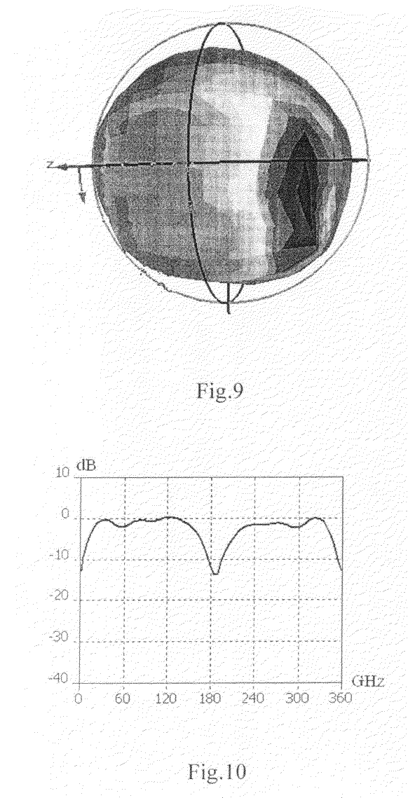

An antenna gain may also be detected in the simulation experiment. The so-called antenna gain is a power density ratio of signals generated by an actual antenna and an ideal radiation unit at the same point in space, in a condition that the input powers are equal. Thus, the antenna gain quantitatively describes a degree of an antenna concentrating input power for radiation. FIG. 8 is a coordinate system view of an antenna radiation direction in the simulation experiment. Based on the coordinate system of FIG. 8, FIG. 9 is a 3D view for the antenna gain at the GSM frequency band. The antenna has a direction pattern and a gain approaching an omni-direction. The coordinate system for the radiation direction diagram is shown in FIG. 8, wherein the aerial direction for the dipole is Y direction, the reference ground and the earth are in the center of the coordinate system, and the antenna unit is on the left of the coordinate system with an average gain of about 0 dBi.

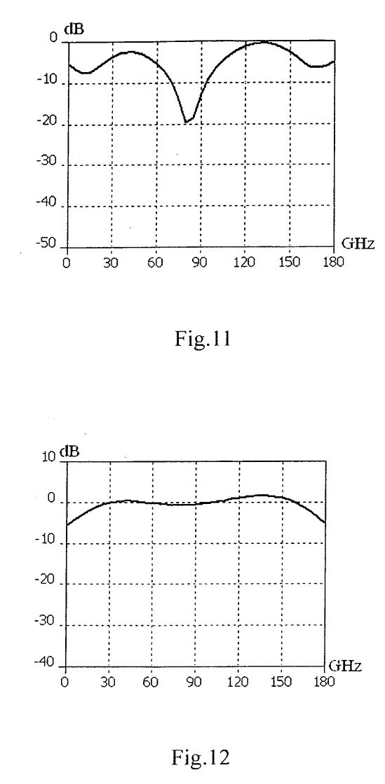

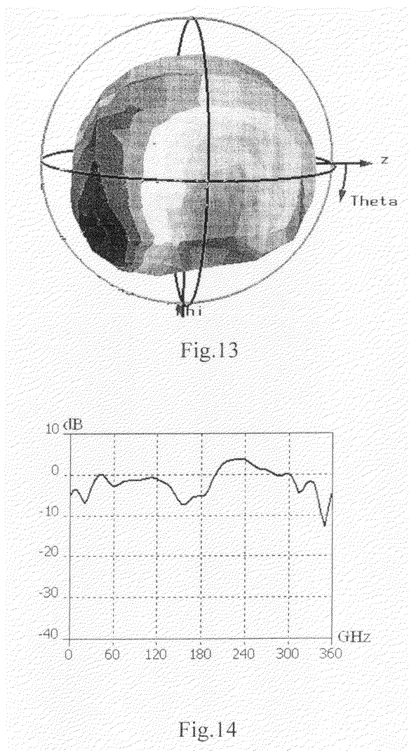

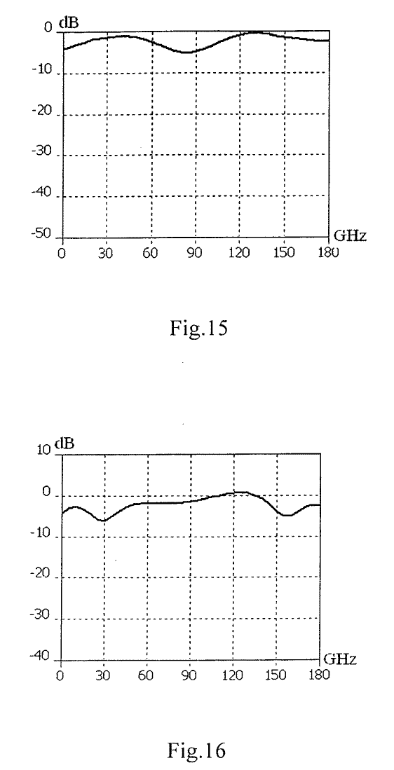

FIG. 10, FIG. 11 and FIG. 12 are X-Y, X-Z, and Y-Z planing views for gains of the antenna at the GSM frequency band of 980 MHz. FIG. 13 is a 3D view for the gain of the antenna at the DCS/PCS frequency band, with an average gain of about 0 dBi. FIG. 14, FIG. 15 and FIG. 16 are X-Y, X-Z, and Y-Z planing views for gains of the antenna at the GSM frequency band of 1780 MHz. The simulation experiments show that it will have a good utility with the antenna gain higher than 0 dBi.

The above is only the preferred embodiments of the present invention and the present invention is not limited to the above embodiments. Therefore, any modifications, substitutions and improvements to the present invention are possible without departing from the spirit and scope of the present invention.

What is claimed is:

1. An antenna, comprising a reference ground, a first radiation branch and a second radiation branch;
the reference ground comprising a first grounding point and a second grounding point;
the first radiation branch being connected to the reference ground via the first grounding point;
the second radiation branch being connected to the reference ground via the second grounding point;
wherein a slot is formed between the first radiation branch and the second radiation branch, and a distributed capacitance for coupling a signal is formed by coupling the first radiation branch and the second radiation branch via the slot;
a connecting point via which one end of the second radiation branch for coupling the signal is connected to a radio frequency (RF) feed line is a feeding point, the feeding point being arranged between the first grounding point and the second grounding point.

2. The antenna of claim 1, wherein the first radiation branch is a coplanar wave-guide coupling radiation branch.

3. The antenna of claim 1, wherein the second radiation branch is a planar inverted-F antenna radiation branch.

4. The antenna of claim 1, wherein non-grounding ends of the first radiation branch and the second radiation branch extend in a same direction or in different directions.

5. The antenna of claim 1, wherein the RF feed line is any one of a coaxial line, a micro-strip line, a strip line, or a wave guide.

6. The antenna of claim 1, wherein the coplanar wave-guide coupling radiation branch is a zigzag sheet metal or in a three-dimensional (3D) structure formed by folding a planar sheet metal.

7. The antenna of claim 1, wherein the planar inverted-F antenna radiation branch is a T-shape sheet metal or in a 3D structure formed by folding a planar sheet metal.

8. The antenna of claim 1, wherein the reference ground is a planar sheet metal, or in a 3D structure formed by folding the planar sheet metal.
